(19) United States
(12) Patent Application Publication
(10) Pub. No.: US 2009/0204521 A1
(43) Pub. Date: Aug. 13, 2009

(54) METHOD OF AND SYSTEM FOR WEB-BASED MANAGING AND REPORTING MORTGAGE TRANSACTIONS

(76) Inventors: Francis E. De Sena, Sarnia (CA); Frank Fazio, Bright's Grove (CA); Jeff E. Nantais, Sarnia (CA)

Correspondence Address: HAYES SOLOWAY P.C., 3450 E. SUNRISE DRIVE, SUITE 140, TUCSON, AZ, 85718, US

(21) Appl. No.: 12/335,217

(22) Filed: Dec. 15, 2008

Related U.S. Application Data
(60) Provisional application No. 61/013,564, filed on Dec. 13, 2007.

(51) Int. Cl. G06Q 40/00; G06F 15/16; G06Q 30/00

(52) U.S. Cl. 705/34; 709/204; 705/40

(57) ABSTRACT

A system and method for web-based mortgage/loan reporting and management are provided. A electronic mortgage is created. The mortgage is reported to parties involved. A funds request can be sent to a funding party such as a financial institutions. When a funding acknowledgement has been received a final mortgage report is generated and sent to the relevant parties for confirmation of completion of the mortgage.

### TECHNICAL FIELD

The present invention relates to financial software applications and systems, and in particular to a method of and system for mortgage transaction management and reporting.

### BACKGROUND

Banks, Mortgage Companies and Lenders require confirmation of mortgage or security registration in relation to loans made for real property and the only manner in which to receive this information is by a written report/certificate including all of the required information as set out by the Banks, Mortgage Companies and Lenders. This may take several days or weeks and more likely several months to complete and receive, and there are also the inconveniences of lost reports, Lenders staff having to pursue Reports and Lawyers and Lenders having to then re-collate all of their Reports and Documents due to the delay. Once the paper Report is received it must then be reviewed and approved for completeness or else the process starts all over again.

This practice has resulted in a number of issues, including increased risk on the part of Lenders, inability for Lenders to re-securitize their portfolios, exposure and fraud. Lawyers and third parties that are responsible for the registration of a mortgage/security and for the written report/certificate do not currently have an efficient, complete and responsive way in which to provide the written report/certificate/confirmation to Banks, Mortgage Companies and Lenders in a form satisfactory to the Lender and in a timely way. This has created more issues and compounded the already existing issues and problems.

Some existing conveyancing systems provide simple reports but they are typically just one-way email services in which reports are delivered from the lawyer to the Lender without any interactivity. Reports are generated and sent without the Lender and lawyer having the opportunity to view or provide inputs, or even receive confirmation that reports have been sent and received.

Other known conveyance systems provide one-way paper reporting using a ‘middle man’ concept where management of the data and report generation is outsourced to a services provider. This services provider pushes mortgage documents by email to a lawyer's computer and the lawyer has the client sign the mortgage docs and fax them back to the services provider for approval. Because of the service provider's lack of intimacy with the transaction and possibility a lack of understanding of the legal requirements, it is very easy for errors to appear in the documents, requiring lawyers to place phone calls and send faxes back and forth until the documents are correct.

Accordingly, there is a need for an improved method of and system for managing and reporting mortgage transactions.

### SUMMARY

It is therefore an object of the invention to provide an improved method of and system for managing and reporting on mortgage transactions.

Most attempts to provide such a system have been unsuccessful largely because they have focussed on the wrong question. The focus has been on the delivery of instructions and funds from Lenders to Lawyers, but the right question should not be on the ‘front end’ of the transaction but rather ‘back end’ of the transaction—‘how do you make it so that the report is done immediately, efficiently and completely without either the Lender or the Lawyer having to compromise any of its obligations and requirements?’

The present disclosure focuses on the ‘back end’ or reporting part of the transaction and provides Banks, Mortgage Companies and Lenders with an efficient, complete, secure, proprietary and real-time electronic reporting system in relation to mortgage/loan registration and security. It is not merely a bulletin board, an email-based reporting system or an Adobe-based system which requires documents to be printed out and reviewed for accuracy and completeness.

In an aspect of the present disclosure there is provided a method of providing web-based mortgage reporting and management, the method comprising the steps of: creating a mortgage; generating a mortgage report; generating a funding request; receiving a funding acknowledgement; and generating a final report.

In another aspect of the present disclosure there is provided a system for web-based mortgage reporting and management comprising: a memory; a processor for executing the steps of: creating a mortgage; generating a mortgage report; generating a funding request; receiving a funding acknowledgement; and generating a final report.

Other aspects and features will become apparent to those ordinarily skilled in the art upon review of the following description of specific embodiment of the invention in conjunction with the accompanying figures.

### BRIEF DESCRIPTION OF THE DRAWINGS

Further features and advantages of the present invention will become apparent from the following detailed description, taken in combination with the appended drawings, in which:

FIG. 1 presents a schematic diagram of a network-based system for managing and reporting mortgage transactions;

FIG. 2 presents an illustration of the dashboard webpage;

FIG. 3 presents an illustration of a mortgage detail dashboard webpage;

FIG. 4 presents an illustration of a Solicitor's document facility webpage;

FIG. 5 presents an illustration of a Lender's document centre login webpage;

FIG. 6 presents an illustration of a Lender's document download centre webpage;

FIG. 7 presents an illustration of a role-based security policy and specialized options webpage;

FIG. 8 presents an illustration of a user account customization webpage showing role and policy security options;

FIGS. 9a-9f present illustrations of an interim report template;

FIGS. 10a-10f present illustrations of a funding report template;

FIGS. 11a-11f present illustrations of a final report template;

FIG. 12 presents an action processing flow diagram;

FIG. 13 presents an application page flow diagram; and

FIG. 14 presents a Lender's application path flow diagram.

It will be noted that throughout the appended drawings, like features are identified by like reference numerals.

### DETAILED DESCRIPTION

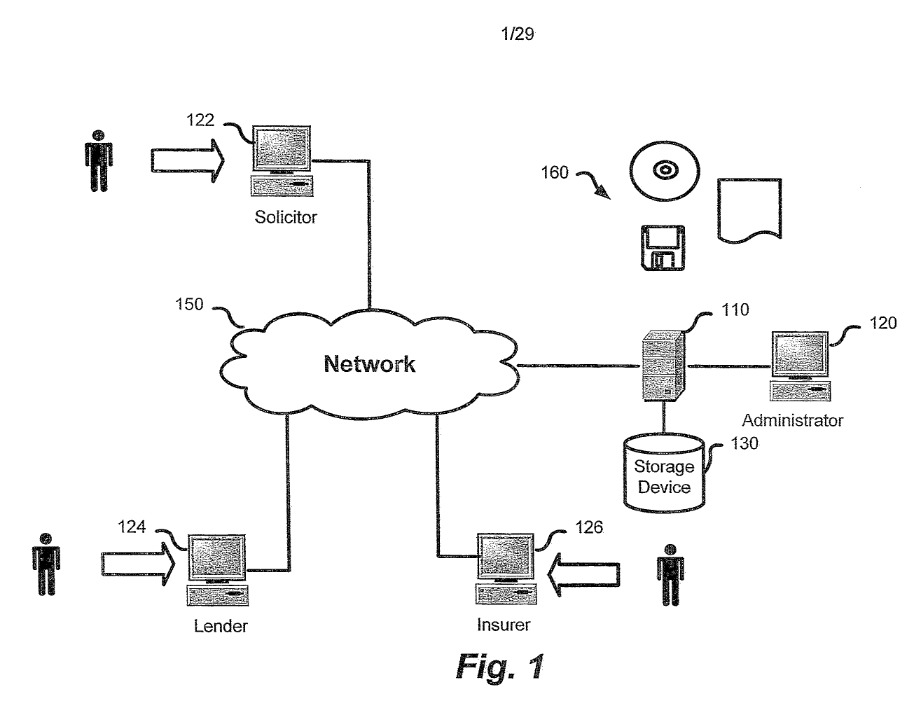

Embodiments are described below, by way of example only, with reference to FIGS. 1 to 14. The present invention provides a method of and system for management and reporting of mortgage transactions.

FIG. 1 presents a schematic representation of a network-based system for managing and reporting mortgage transactions that enables a specialized service for the purpose of reporting legal, financial and time-related data between Lenders, Solicitors representing mortgagors, and affiliated services, such as the insurers. The application is offered using a Service-Oriented Architecture hosted on a server 110 providing a web service over the network 150, which can be interacted with on various levels. The network 150 may include the Internet and any number of related data communication networks and media such as Ethernets, Wide Area Networks (WANs), Local Area Networks (LANs), digital wireless networks and similar hard-wired, optical and wireless networks. The server 110 stores mortgage transaction information in database 130. The application may use industry-standard technologies, which may include, but are not limited to, the following:

Apache Web Server

PHP Application Server

MySQL™ Database Server

Nitrogen Application Framework

Javascript Web Scripting Language

Prototype Javascript Framework

AJAX Scripting Toolkits

The application may be developed based on the utilization of a number of standards, including:

XHTML Language

CSS Visual Styling

XML Extensible Markup Language

SOAP Messaging Framework

SSL Internet Security Layer

Interaction with the system can be performed using an Internet browser such as Microsoft Internet Explorer™ or Firefox™ accessible directly by a computer 120 or through a network or Internet by computers 122, 124 and 126. Interaction between an affiliated web service application through the use of the SOAP protocol is also provided. Custom developed ‘middleware’ can be used, to integrate system with an affiliated service.

The system uses a Model-View-Controller (MVC) software development architecture. This architecture is described as the separation of an application's data model, user interface, and control logic into three distinct components so that modifications to one component can be made with minimal impact to the others.

The system provides many innovative features and advantages over previous systems, including for example: electronic and automatic delivery of non-compliance reports, certified title insurance confirmation as part of the report to the Lender, and detailed status reports for all transactions. All reports are typically certified, real-time and secure.

Although the end result of a system transaction is to fulfill the Lender's requirements for reporting and securing of the final results of a mortgage transaction, the system permits the immediate communication of activity regarding a mortgage transaction between the Solicitor representing the Mortgagor and the Mortgagee (Lender) at any time during the Mortgage transaction process providing Real-time Interactive Mortgage Reporting. The system acts as a non-partisan data transfer agent between associated parties for the purpose of reporting on Mortgage transaction activity.

The system has a specially designed process for efficiently managing the reporting needs of lending organizations. This includes features that permit customization of the application to meet needs of individual lending organizations. The system uses automation to select and notify Solicitors and Lenders of exceptions in the Mortgage process by way of email notifications and a specialized graphical dashboard within the application.

Multiple ‘input paths’ are provided which allow Mortgage data to be populated in a number of ways, which may include, but are not limited to:
Manual input by a user, through a web interface;
Automated input from an affiliated network service, triggered by the user, a pre-defined event, or time-triggered at scheduled intervals—also known as ‘server-pull’; and
Automated input from an affiliated network service—also known as ‘server-push’.

The system provides an electronic pipe or highway as between the lawyer 122 (or paralegal or mortgage processing centre) and the Lender 124 (viewable and inputable by the lawyer and the Lender at all times in real time). This pipe can receive inputs and provide outputs to third parties, all of which is presented into the pipe or system in real time, and is always viewable and inputable by the lawyer and Lender. The Status and Reports bar of the system may be placed onto third party conveyance systems. The data residing in the pipe is then available for use by a Lender in order that they can provide mortgage instructions for new mortgages on the same property with such data already having been vetted by a lawyer or paralegal. The electronic mortgage instructions enables the automatic use of the considerable data, without the lending having to input it manually each time.

Other uses that come off of the pipe could include, for example:
reporting to vendors and purchasers, which could be done by email or by downloading the report to a portable storage device such as a CD, DVD, magnetic disk, optical disk, Flash memory, memory stick, or similar device 160, or even into the memory of a more complex multipurpose device such as a PDA (personal digital assistant), portable email device or cellular telephone. There may not be a need by the vendor or purchaser to view or input into the pipe if they simply require an electronic report or summary of the transaction;
notification of discharges of mortgages to Title Insurance companies. Again, these may be provided by email unless the Title Insurance companies want to have a dashboard of their own. They can then view this event in real time and therefore adjust their claims risk by removing a mortgage previously title insured, off of their records;
notification of fire insurance coverage;
etc.

All of these last items are natural to and already slotted in the system in order to make the real estate transaction more efficient, quicker, and with fewer mistakes for the lawyer, the banker and the third parties.

This system provides a significant advance over previous conveyance systems which basically provided emails of static reports without any interactivity or any confirmation that a report has been sent or received. The system provides interactivity and viewability continuously and in real time, to the parties who are entitled to interact with and view the data as authorized, through the entire life cycle of the mortgage preparation, approval, funding and final completion. This is provided through an automated interactive Status and Report Dashboard style program rather than through a manual, ‘middle man’ concept as described in the Background above. The interactivity and viewability of the system allows parties to identify and correct errors quickly and easily, allowing them to avoid the arduous manual interactions of fax and telephone, required in the past.

The system provides Client Reporting which enables a template-based report to be sent to the Mortgagor (client) of a Mortgage record. This report adds value to the Solicitor's service to the client. This service is enabled by defining the Mortgagor's email address and having the functionality to submit the report electronically on completion of the Final Report. Optionally, a downloadable PDF document version could be generated for offline packaging (CDROM, etc.), or for printing and physical delivery to the client.

Electronic mortgage instruction provides the ability to issue mortgage instructions from the existing Lender dashboard to the Solicitor. This allows the Lender to pre-define an arbitrary portion of Mortgage information, thus effectively increasing the efficiency with which a Solicitor can accurately report on the completion of a Mortgage transaction.

SOAP-based mortgage reporting pipeline is an application of the SOAP-protocol which allows partnered companies to interact with Mortgage records through a number of pre-defined actions available through a secured Internet tunnel as system-to-system processes. This permits the transfer of data, documents, mortgage status and associated information from one organization's database application to and from the system either through user-controlled means or via automated server-level actions. The completed SOAP facility, API (Application Programming Interface), would be available as a subscription- or partner-based solution.

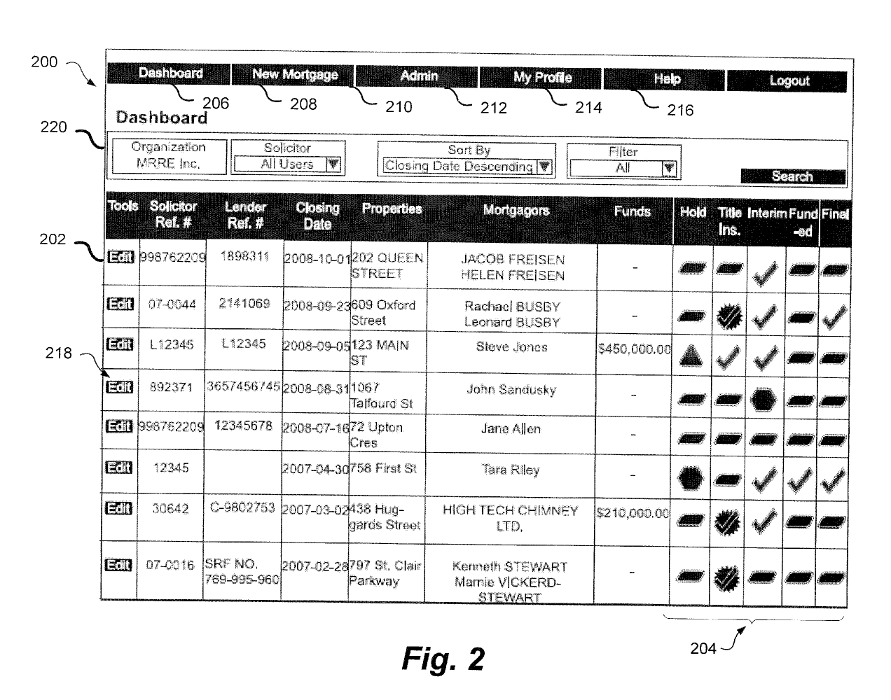

FIG. 2 presents a dashboard 200 with a search and filter bar 220 at the top, and seven mortgages with their details 202, in various stages of progress. The dashboard is comprised of three major areas: Main Navigation, Dashboard filter bar, and the list of mortgages available to the user.

The Main Navigation area includes the following menu items which effect the functionality described:
Clicking on the ‘Dashboard’ link 206 sends the user to the Dashboard page currently being described.
Clicking on the ‘New Mortgage’ link 208 sends the user to the page for creating a new mortgage in the System.
Clicking on the ‘Admin’ link 210 sends the user to the administration section of their account where they can perform tasks such as purchasing credits, creating users, assigning user security, and updating their organization information.
Clicking on the ‘My Profile’ link 212 sends the user to the profile management section of their account where they can perform tasks such as editing profile information, changing their password, editing trust account details, and creating an authorization form.
Clicking on the ‘Help’ link 214 sends the user to the help center where users may submit support requests, review current notices, and search the knowledge base.
Clicking on the ‘Logout’ link 216 ends the user's session within the application and sends them to the login page.

On the dashboard filter bar the user is provided with information indicating which organization and solicitor's mortgages are being displayed in the list below. Users with appropriate access can choose to view other solicitor's mortgages within their organization through the select list available in the filter bar. Users can sort and filter the list of mortgages through the options available within the select list ‘Sort By’ and ‘Filter’ in the filter bar.

The list of mortgages displayed is based on the filtering and sorting options selected from the dashboard filter bar. The details displayed for each mortgage are typically: Solicitor Reference Number, Lender Reference Number, Closing Date, Properties list, Mortgagors list, Funds available, and the status icon of each mortgage mode (Hold, Title Insurance, Interim Report, Funding Report, Final Report). Of course, other data may also be stored and displayed. Moving the mouse over each of the status icons will result in a popup window showing more status details.

The stage of each mortgage is displayed using the status symbols in the five columns 204 on the right, which represent the following:
Hold: A hold status has been issued, an error or discrepancy in the report, or the actual mortgage transaction has occurred and needs to be addressed by the Solicitor.
Title Ins.: The mortgage has been Title Insured. Title insurance policy numbers that have been populated into the system by a Title Insurance number will have a Gold Seal and Check mark illustrating the source has been authenticated.
Interim: Illustrates that an Interim report has been issued by the Solicitor to the Lender.
Funded: Illustrates that the Mortgage has been funded by the Lender, and the Solicitor may proceed with the Mortgage transaction.
Final: Illustrates that a Final report has been issued by the Solicitor to the Lender. A gold seal on the check mark symbol represents that the Lender has acknowledged receipt.

Clicking on the ‘Edit’ button 218 located next to each mortgage in the list allows the user to work with the selected mortgage. The user is able to view and update mortgage details, and send mortgage reports.

Thus, the dashboard 200 presents the user with a full overview of current mortgages they are working with, at various stages in their processing, all at a glance. The ‘Status lights’ within the dashboard, and the stages within a mortgage process in which they represent, have been developed through extensive discussion and research with Solicitors in practice, with a common goal of simplicity and ease-of-use.

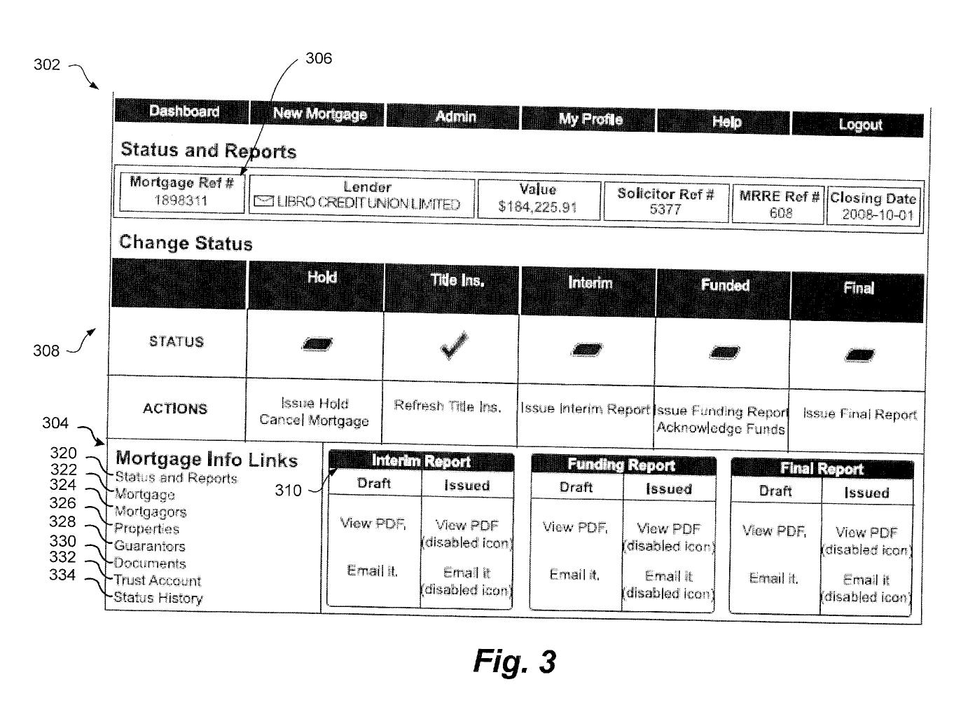

FIG. 3 presents the Mortgage Detail Dashboard in the ‘Status and Reports’ page 302 of the user-selected mortgage. There are four specific sections to this page: Mortgage Information navigation 304, Mortgage Summary Bar 306, Mortgage Status Bar 308, and the Report View/Email tools 310. The menu at left under the Mortgage Information heading 304 provides access to add or modify various components of the Mortgage data.

The dashboard lights for a selected mortgage, and action links below 308 are provided to allow the Solicitor to change the status of the mortgage by issuing reports, funding requests, and/or hold notices. These functions are available in a sequence, only permitting access to the next action once a prerequisite action has been issued. For example, Funding cannot be requested prior to the issuance of an interim report. Below this component are tools to print an email, or an issued or draft version of each report as they are issued. Disabled actions are presented in grey, illustrating that a particular function is unavailable until other prerequisite actions are processed.

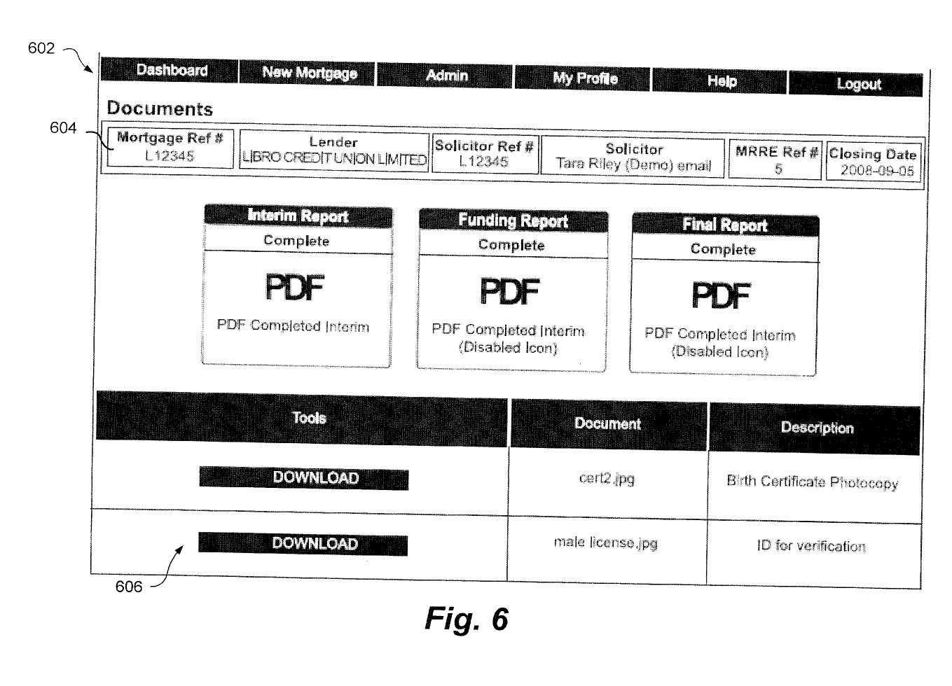

Mortgage Information 304 functions provide the following functionality:
Clicking on the ‘Status and Reports’ link 320 will send the user to the Mortgage Detail Dashboard page (see FIG. 3) currently being described.
Clicking on the ‘Mortgage’ link 322 will send the user to the main mortgage details page where they can view and edit mortgage details.
Clicking on the ‘Mortgagors’ link 324 will send the user to the mortgagor management section for the selected mortgage. Users can add, edit and delete mortgagors associated with the selected mortgage.
Clicking on the ‘Properties’ link 326 will send the user to the properties management section for the selected mortgage. Users can add, edit and delete properties associated with the selected mortgage.
Clicking on the ‘Guarantors’ link 328 will send the user to the guarantor management section for the selected mortgage. Users can add, edit and delete guarantors associated with the selected mortgage.
Clicking on the ‘Documents’ link 330 will send the user to the solicitor's document facility for the selected mortgage (see FIG. 6). Users can browse, upload, edit and delete document files associated with the selected mortgage.
Clicking on the ‘Trust Account’ link 332 will send the user to the trust account details page for the selected mortgage. Users can view or edit trust account details associated with the selected mortgage.
Clicking on the ‘Status History’ link 334 will send the user to the status history page for the selected mortgage where users will be able to view all history.

On the mortgage summary bar 306 information for the selected mortgage is provided such as Mortgage Reference Number, Lender Name and quick link email to Agent, Mortgage Value, Solicitor Reference Number, system Reference Number, and Closing Date. These data are stored in the database record for the selected mortgage, in the storage device 130.

On the mortgage status bar 308 the current mortgage status icons (Hold, Title Insurance, Interim Report, Funding Report, Final Report) are shown. The status of these items, of course, will be same as those of section 204 of FIG. 2. Moving the mouse over each of the status icons results in a popup window showing more status details. Below the status icons are the available actions for each of the status’. Depending on current status of the mortgage the user is be able to perform actions such as Issue Hold, Cancel Mortgage, Issue/Re-Issue Interim Report, Issue/Re-Issue Funding Report, and Issue/Re-Issue Final Report by clicking on the corresponding action item.

For each of the three report 310 types Interim, Funding and Final, users will find a link to view or email a PDF of the corresponding draft or issued report. These reports may be generated head of time or when the user clicks on the menu items.

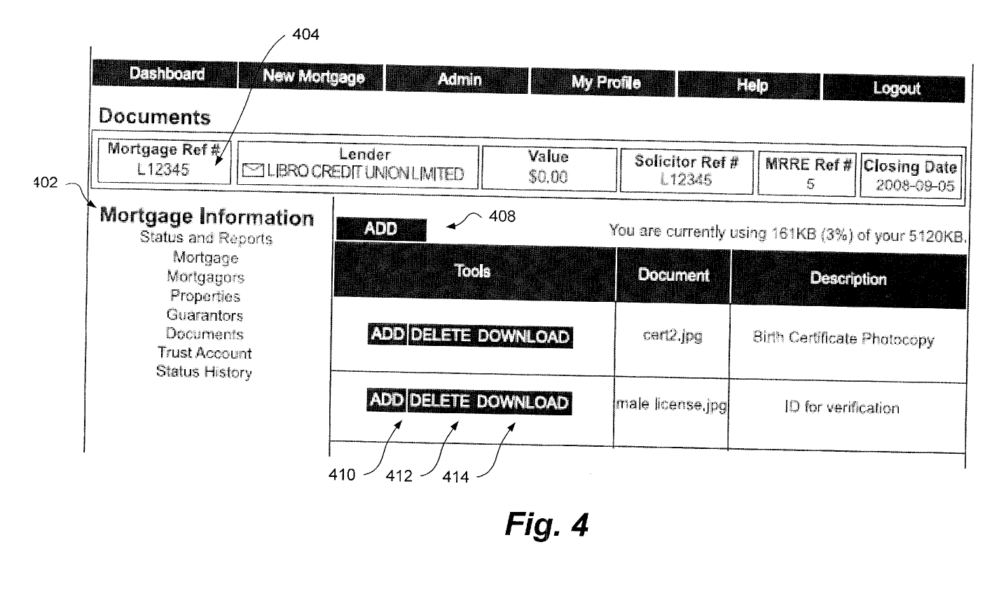

FIG. 4 presents an illustration of an exemplary Solicitor's Document Centre 402, with one document currently uploaded to the system and labelled as a drivers license for identification verification. The Solicitor's Document Centre 402 is where the user can browse, upload, edit, and delete document files to be associated with a selected mortgage.

The Solicitor's Document Centre 402 is comprised of two components. The first component is for the Solicitor to upload various attachments, images and documents that compliment the mortgage report. These may include scanned images of driver's licenses for the purpose of Identification Verification, or even particulars of associated Title Insurance. The second component is for the Lender, or other recipient of a report to be able to download these documents on demand. This access is facilitated by the use of a secure, independent web interface, and is accessed using a security key code, delivered with a mortgage report via email, combined with the recipient's email address. The primary reason for this feature is to alleviate the issues of large bandwidth use, anti-virus and security settings associated with using email attachments. This page also includes the Mortgage Summary Bar 404 and the Mortgage Information Navigation 406 available to help the user navigation through the mortgage quickly and easily.

Any document files that have already been associated with this mortgage are listed in the document list on this page 402. Details displayed in the list include the document filename and the description of the document (if entered). There is also a statement displayed that indicates how much total space the user is using with their document files. Functionality with respect to the individual documents may include the following:
Clicking on the ‘Add’ button 408 will send the user to a page for uploading a new document file.
Clicking on the ‘Edit’ button 410 will send the user to a page for editing the selected document details, such as the description of that document.
Clicking on the ‘Delete’ button 412 will send the user to a “delete” confirmation page for the selected document.
Clicking on the ‘Download’ button 414 will allow the user to save the selected file to their computer.

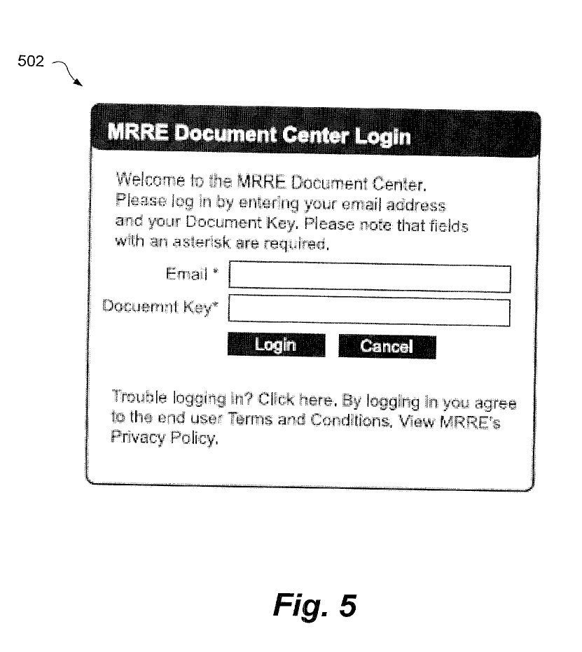

FIG. 5 presents an illustration of an exemplary Lender's Document Centre Access page 502, with key-based login functionality, while FIG. 6 presents an illustration of an exemplary Lender's Document Centre 602, which provides for the direct downloading of associated mortgage documents.

FIG. 5 presents the Lender's Document Centre Access 502 that allows registered and un-registered Lenders access to reports and documents published by solicitors. The Lender's Document Centre Access 502 requires an email and random document key that is assigned to the Lender and emailed upon creation of the report by the solicitor. The Lender can use their email address and document key to login to the Lender's Document Centre of FIG. 6 to download pdf versions of published reports and other document files associated with the reports. Reports could, of course, be issued in other formats, and various security options may be used to block editing, provide digital signatures, encryption, etc.

As shown in FIG. 6, once a Lender has logged into the Lender's Document Centre they will have access to download any published reports that have been directed to them as well as the document files associated with the reports.

The Lender's Document Centre 602 displays a Mortgage Summary bar 604 containing information such as Mortgage Reference Number, Lender Name, Solicitor Reference Number, Solicitor Name and email quick link, system Reference Number and Closing Date. The centre also displays the list of available download files with a ‘Download’ button 606 next to each item. Clicking on the ‘Download’ button allows the Lender to save the file to their computer. These data are stored in the database record for the selected mortgage, in the storage device 130.

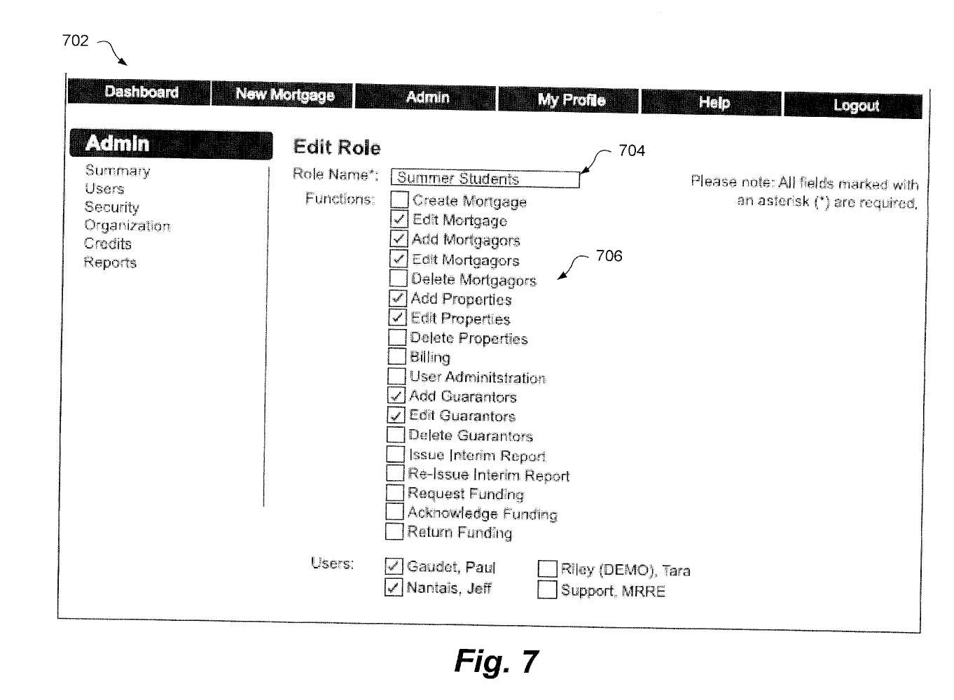

FIG. 7 presents an exemplary interface for the Role-Based Security Policy and Specialized Options 702. The system allows users with appropriate permissions to create multiple roles within their organization and assign other users within their organization to these roles. The roles define what functions users are allowed to perform while logged in. The Role Name 704 is a mandatory field. The user can place checkmarks next to each of the functions that they would like to allow this role to perform. The user then can place checkmarks next to the users 706 they would like to assign to this role. Clicking on a given Role Name causes the users associated with that role to be displayed on the right side of the computer display screen, and for the state of the various security options to be displayed on the left.

Clicking on the various policy boxes 706 enables or disables a given function. These functions may include, for example, the following. Note that this list is not complete as clients may have any manner of requirements depending on their own policies and specifics of their transactions. However, i is useful as a starting point:

Creating mortgages;

Editing mortgages;

Adding mortgagors;

Editing mortgagors;

Deleting mortgagors;

Adding properties;

Editing properties;

Deleting properties;

Billing;

User administration;

Adding Guarantors;

Editing Guarantors;

Deleting Guarantors;

Issuing interim reports;

Re-issuing interim reports;

Requesting funding;

Acknowledging funding; and

Returning funding.

For example, as shown in FIG. 7, Summer Students may be allowed to enter data, but may not be allowed to issue Interim or Final reports. While a policy-based security system is being described here, other security models could also be used.

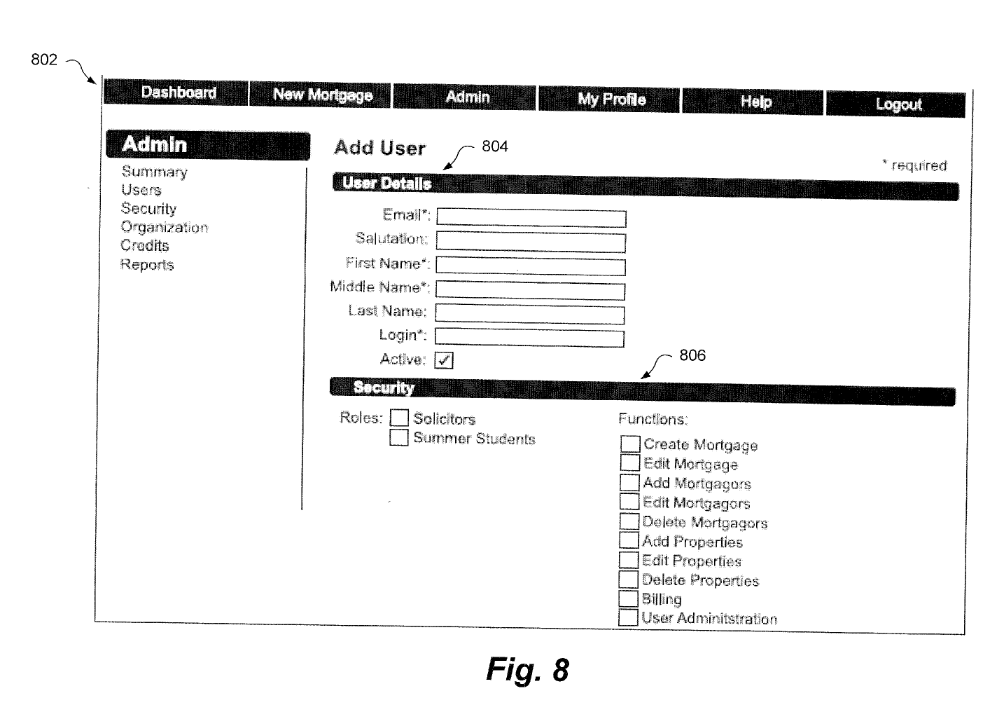

FIG. 8 presents an exemplary User Account Customization page 802 which allows users with appropriate permissions to add, edit and delete users to and from their organization, and to assign security roles to those users. This figure is a sample of adding a User to the logged-in user's organization. The logged-in user would enter the user details in the defined fields, mandatory fields being denoted with an asterix “*”. The user would then choose either an already-defined security role 806 to assign to the user, or manually select the functions this user would have access to by placing checkmarks in the boxes next to the function list. This list is similar to that of FIG. 7, and in fact, would generally be the same for a given application. As noted above, there is no limit to the options that could be included in this list. User Details 804 are displayed in the upper window, so that contact information can be reviewed and amended if necessary. All of this information is stored in the database 130.

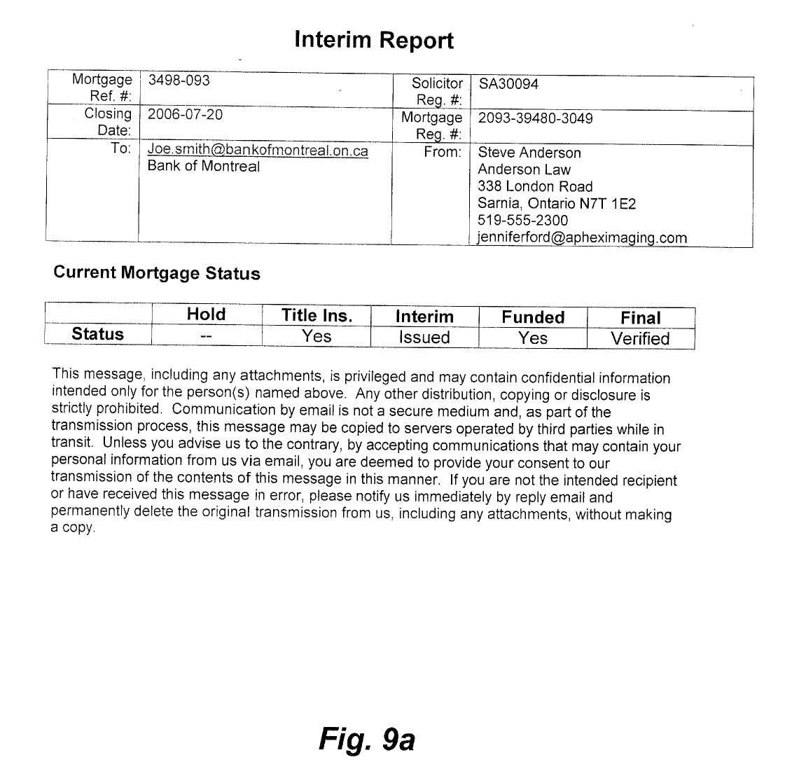

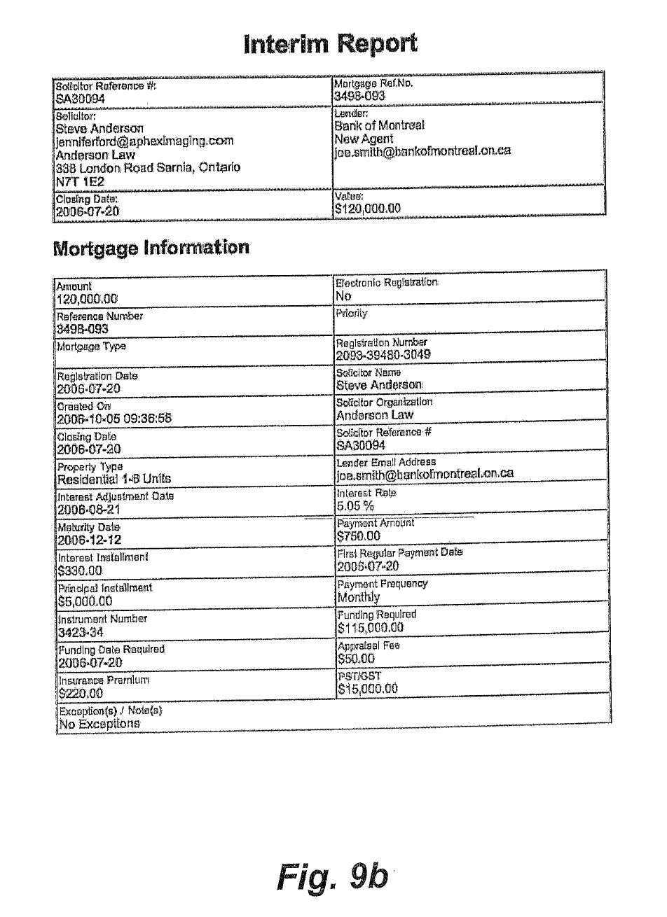

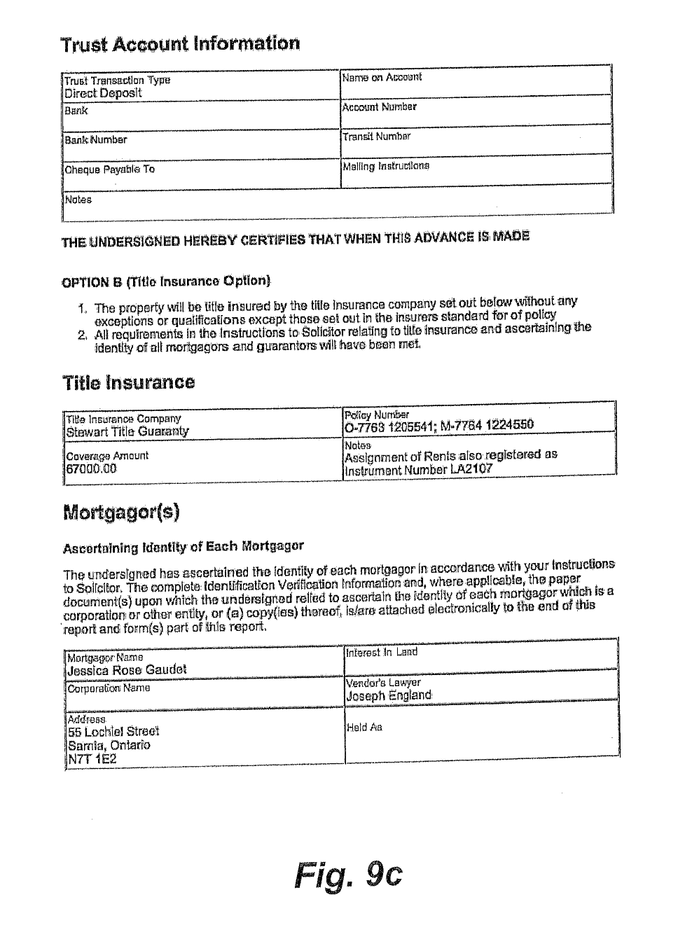

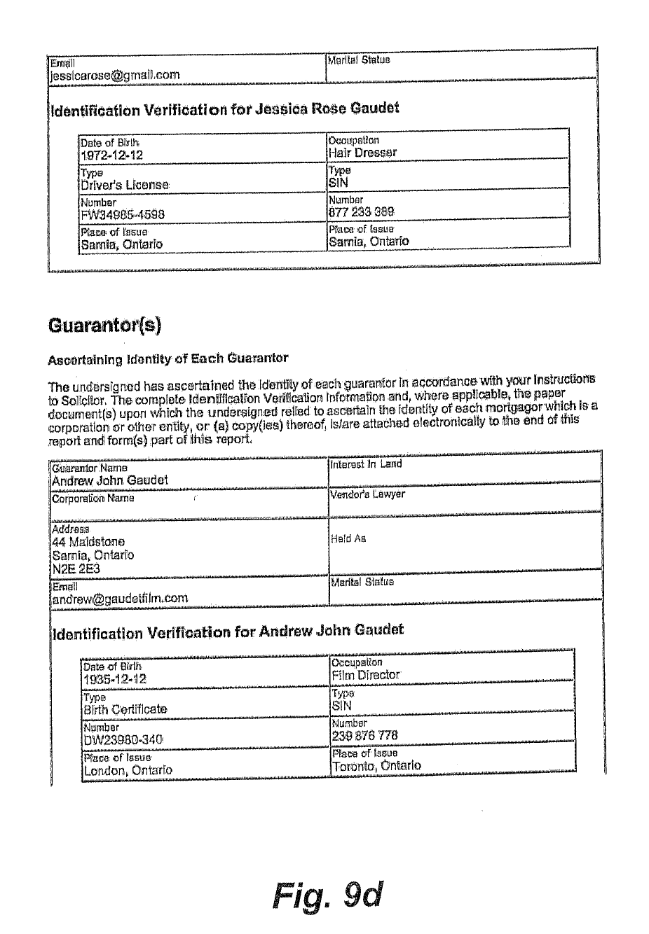

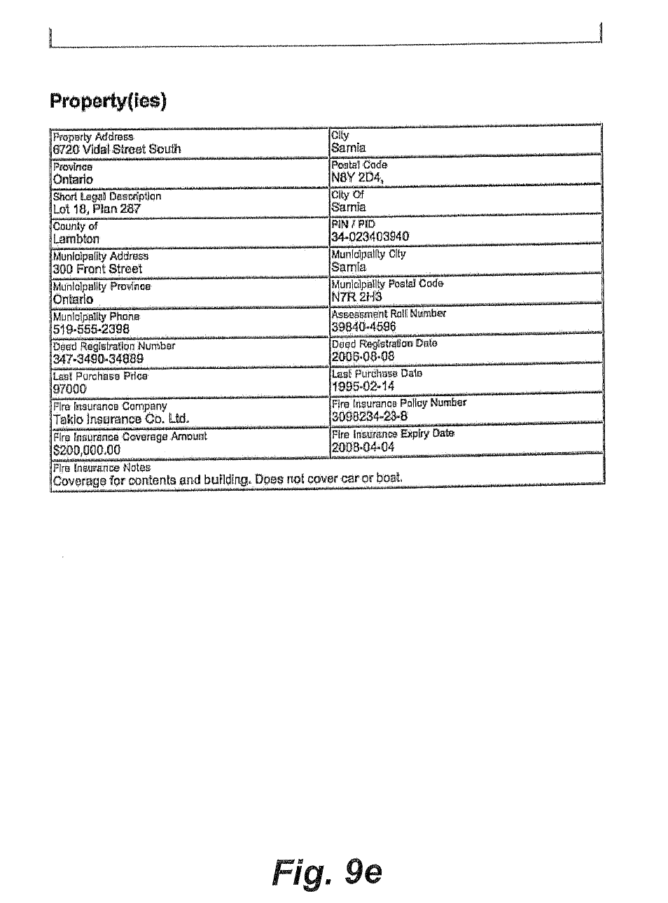

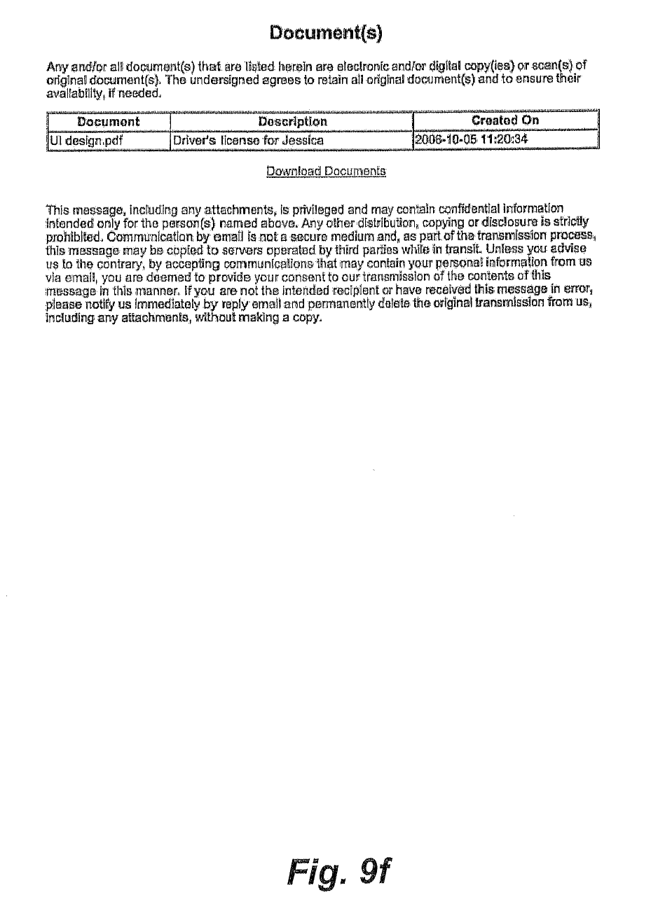

In order to facilitate the use of the system by a Solicitor in reporting to Lender's who may operate at various levels of access and/or have varying degrees of knowledge of the service, the system has built-in functionality to automatically generate reports using a standardized template. FIGS. 9, 10 and 11 illustrate the standard templates for the system reports. In addition, a Lender can easily modify these reports to match their specific report. When a Solicitor creates a mortgage to be delivered to a Lender with custom report templates built, their reports are automatically delivered in their specific template.

The exemplary Interim Report template of FIGS. 9a-9f includes the following sections:
A title block including the mortgage reference, solicitors reference, closing date, mortgage registration number and primary parties in the transaction;
The status of the current mortgage;
Mortgage information;
Trust account information;
Title insurance information;
Mortgagor(s) contact information;
Guarantor's information;
Property(ies) information; and
A listing of documents.

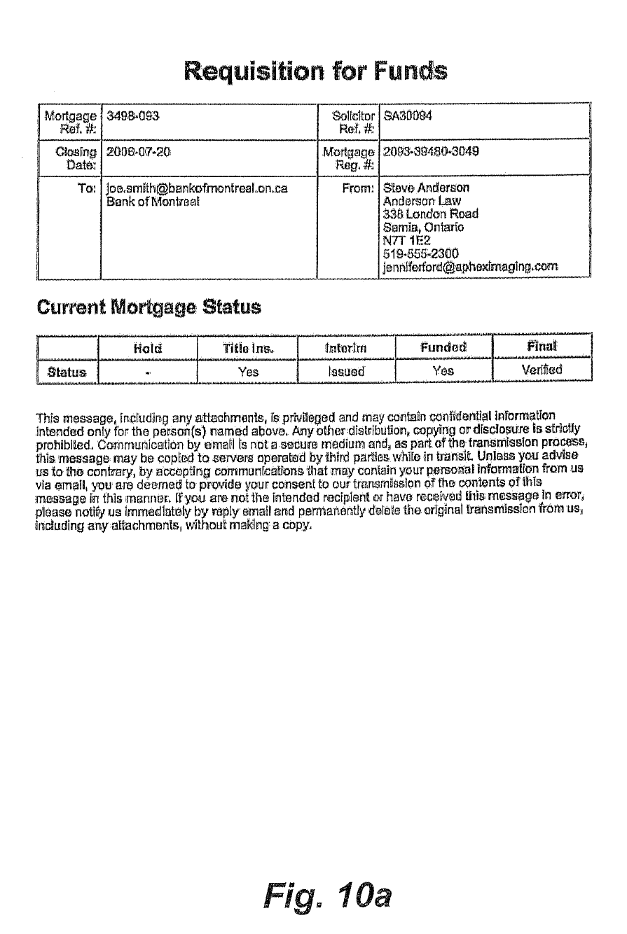

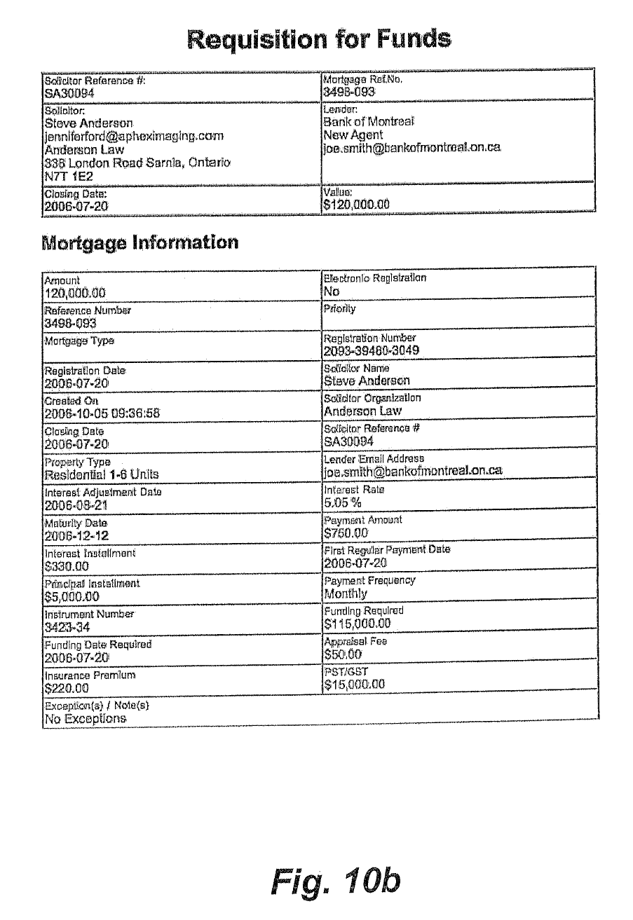

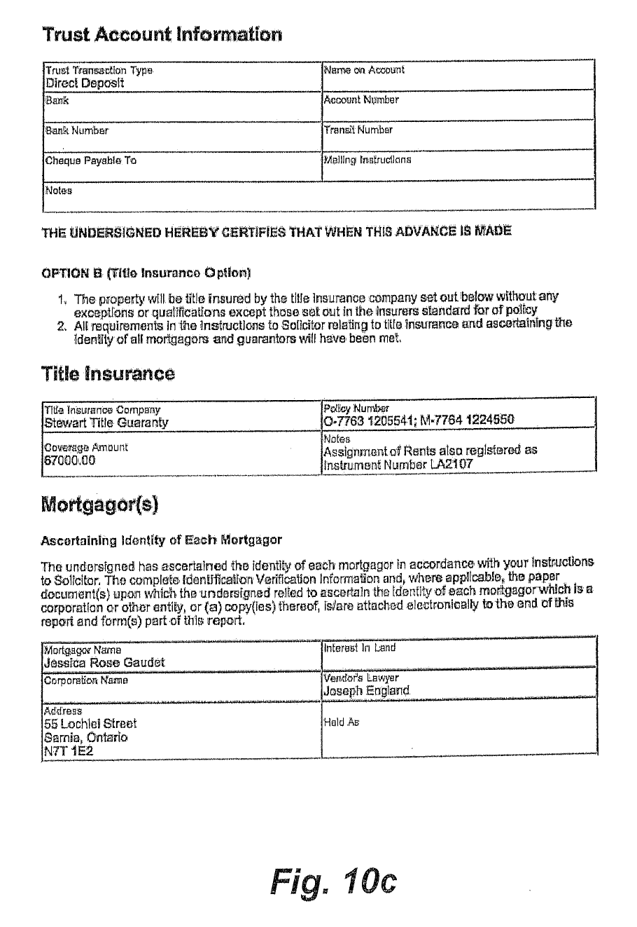

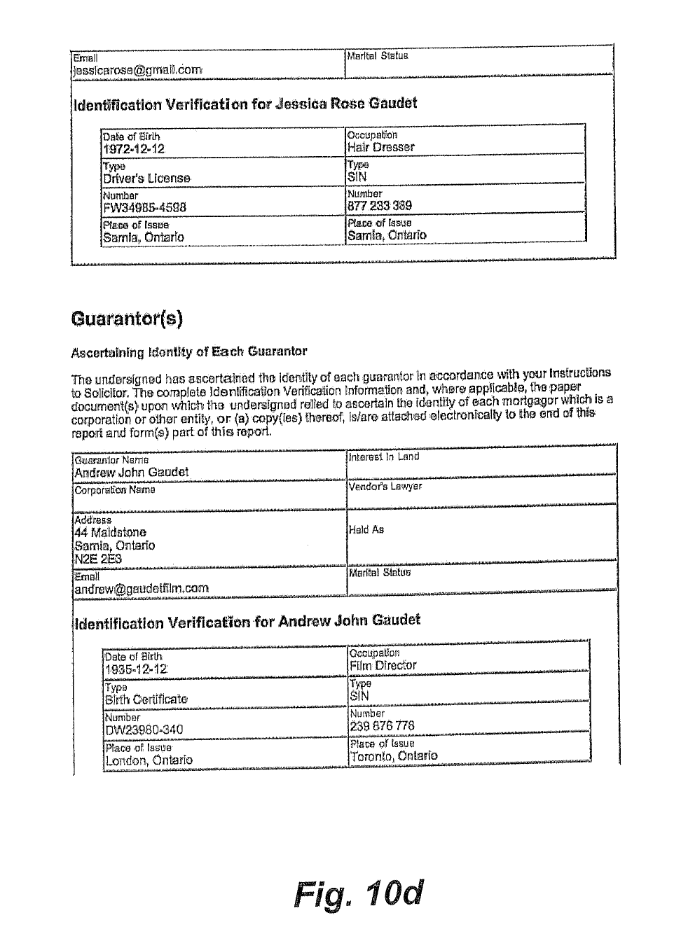

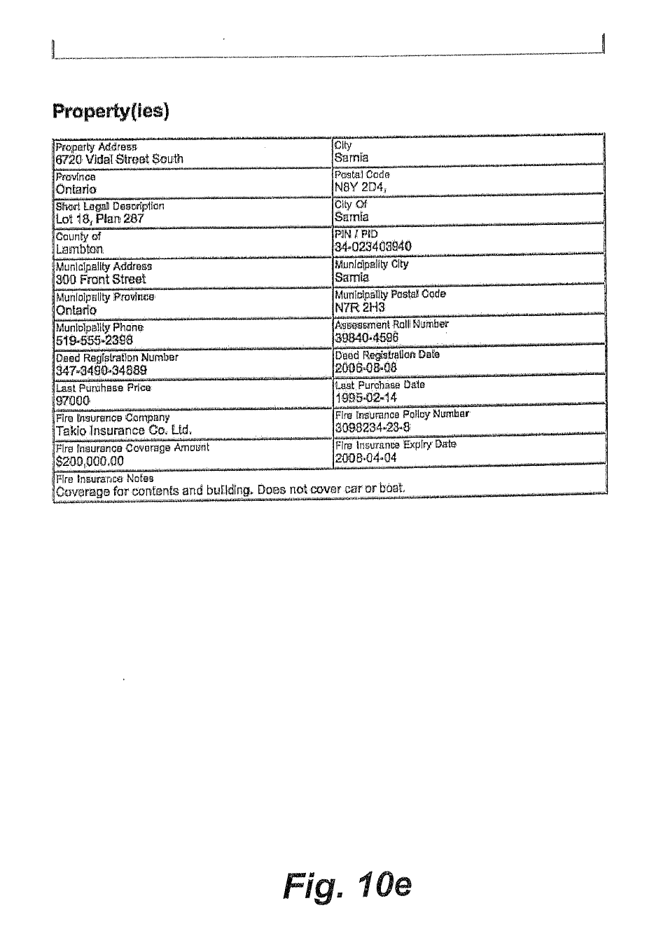

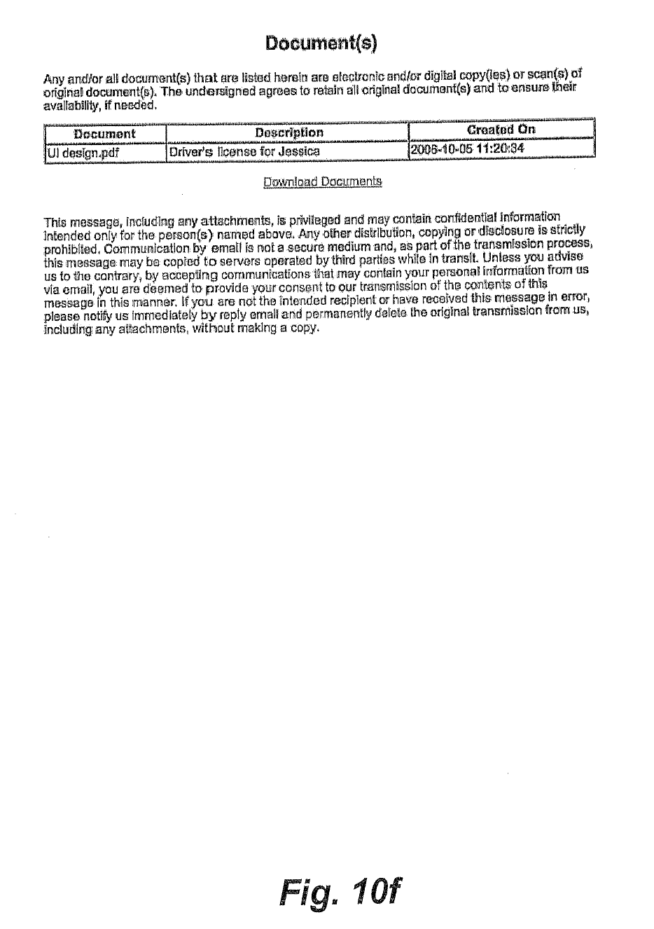

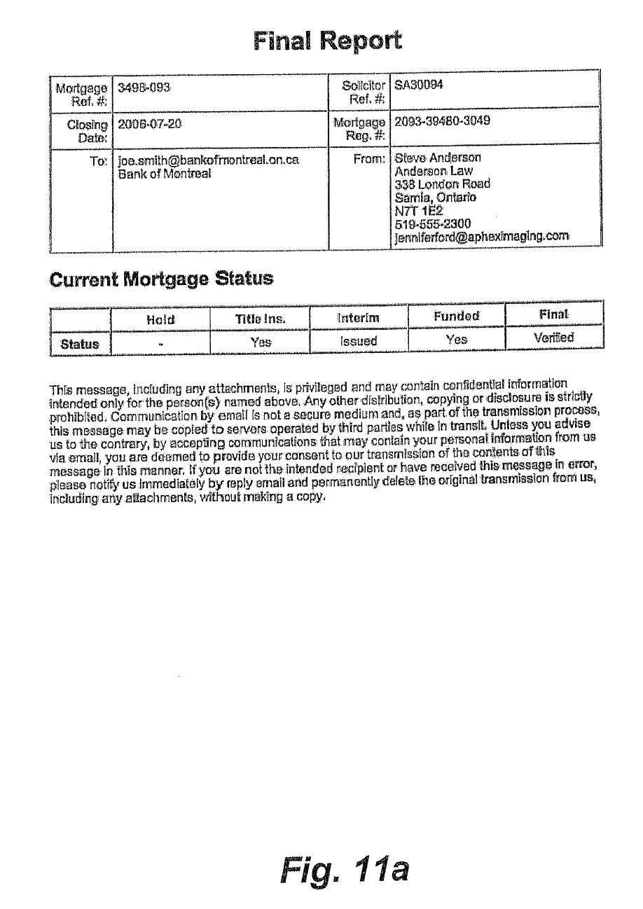

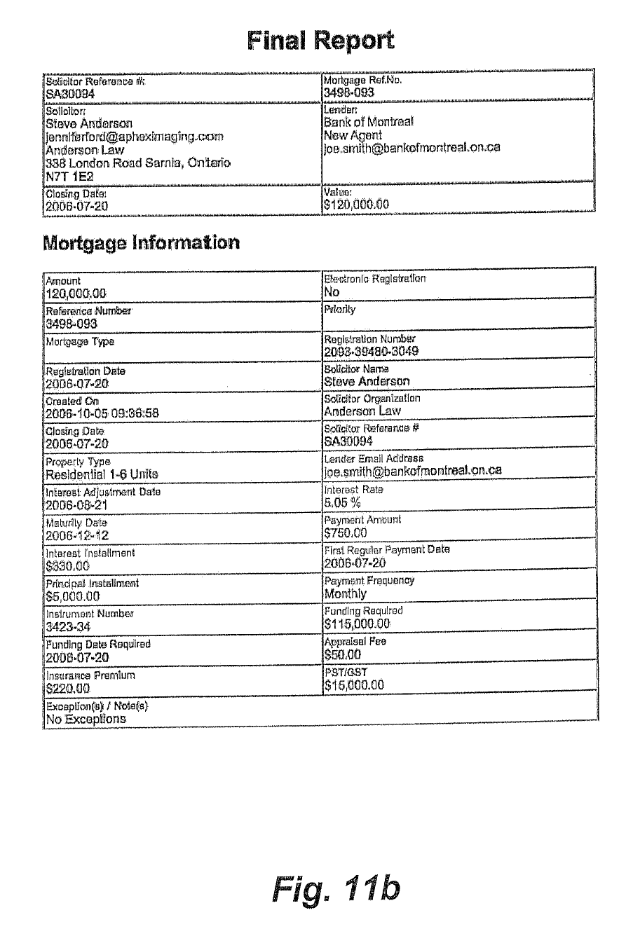

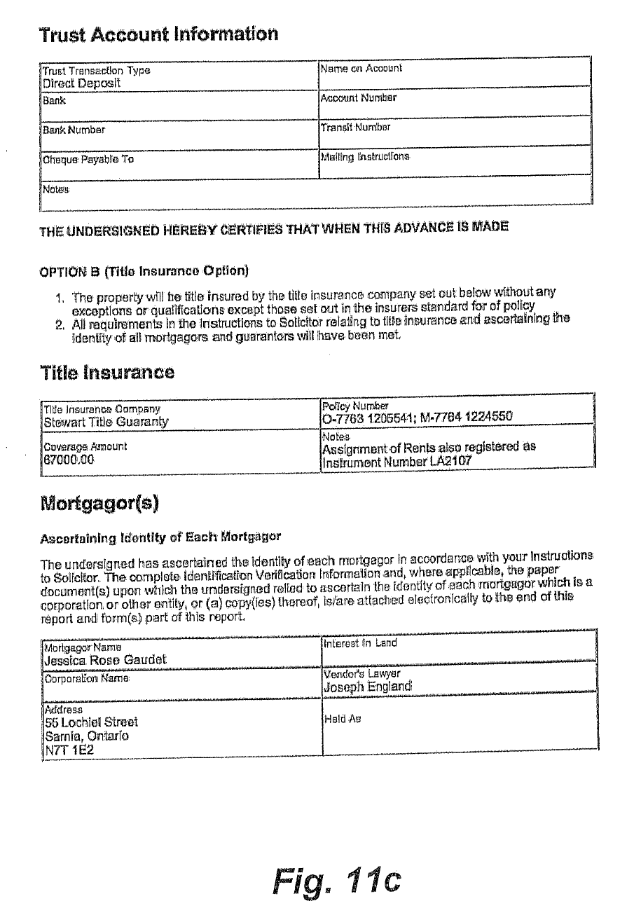

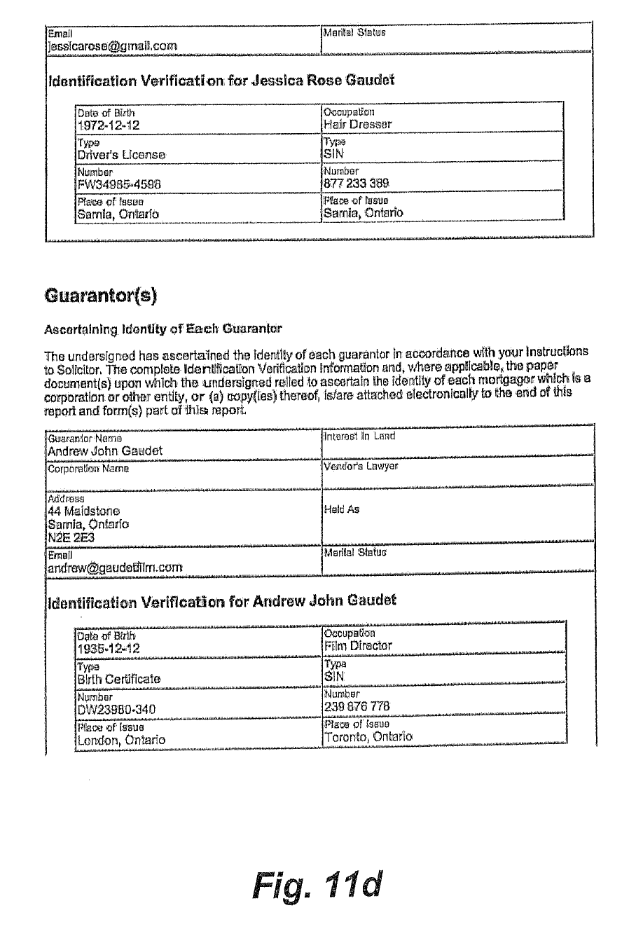

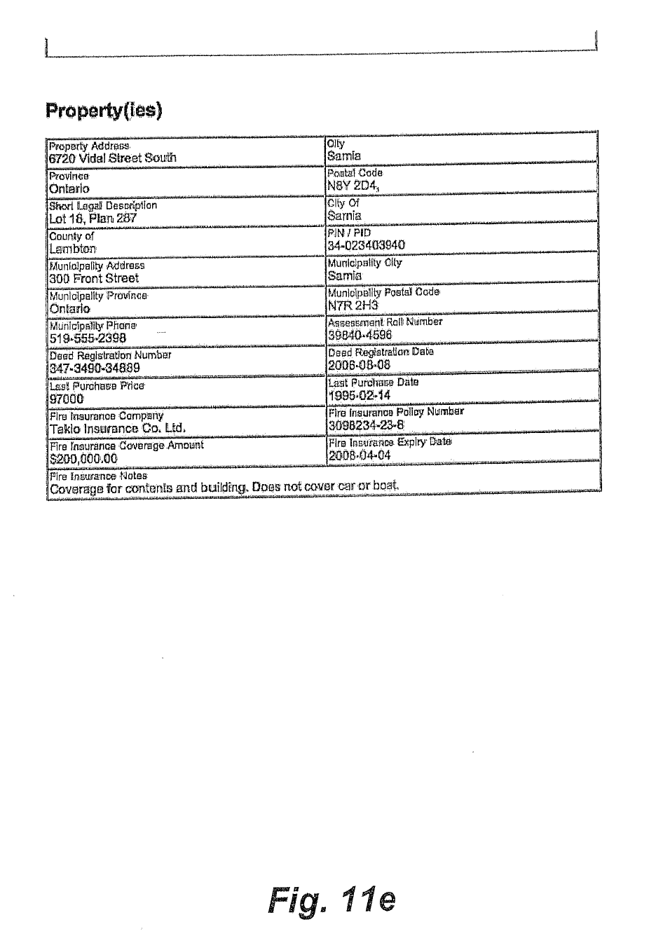

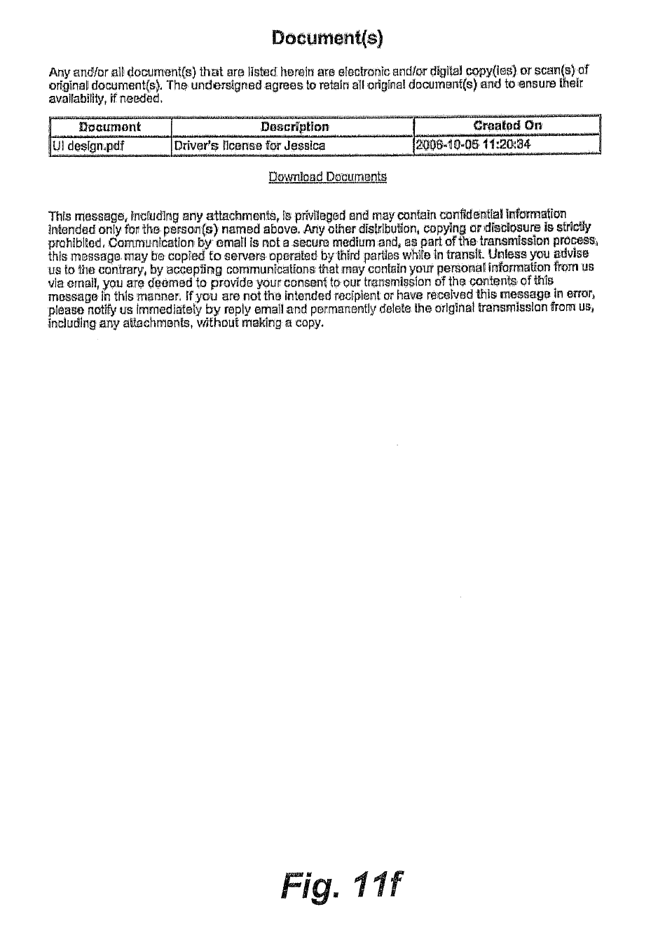

Both the exemplary Funding Report template of FIGS. 10a-10f and the Final Report template of FIGS. 11a-11f include the same data fields and layout as FIGS. 9a-9f (though of course, the titles of these three reports are different). The difference between the reports lies in primarily in the timing and the fields that would be populated at different stages of the transaction. For example, the Lender will have certain expectations if a report identified as an “Interim Report” is received, and some Lenders may wish to receive only certain ones of the reports. The titles of the reports are based on the existing processes and practices that are used in a given jurisdiction. Identifying the reports also allows one to put limitations on the reports—i.e. limiting who can generate, transmit and receive each report.

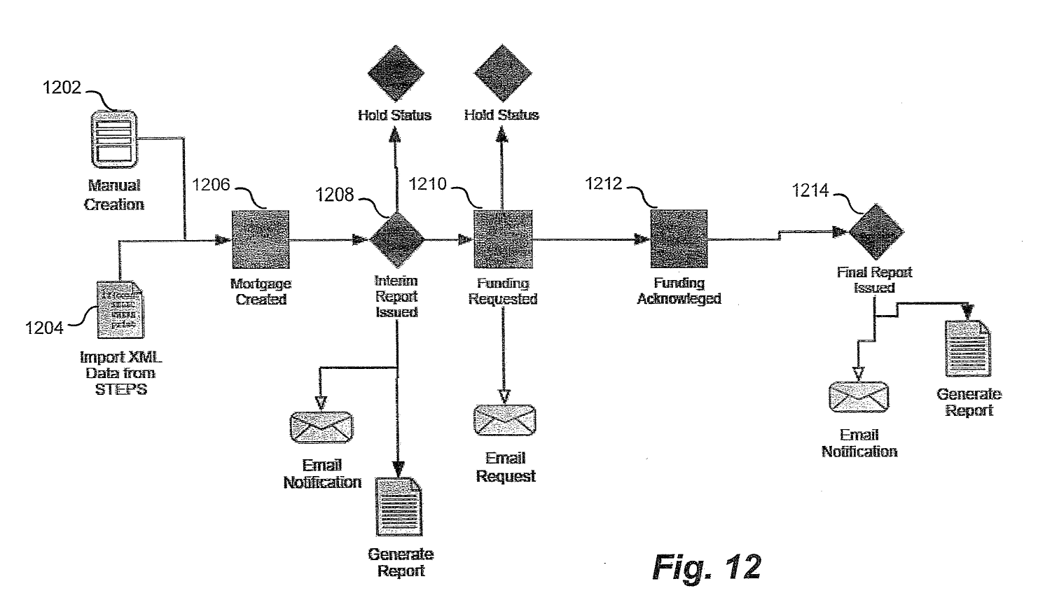

The Action Processing flow diagram of FIG. 12 relates particularly to the displays presented in FIGS. 2 through 7. In short, new mortgages can be created using the GUI of FIG. 2, importing data automatically once the Lender's reference number has been entered via STEPS (Stewart Title & Guaranty's Automated Policy System) or any other integrated data source. Many of such data sources will make matter data available electronically through some mechanism, but even in the worst case scenario, data can typically be parsed from whatever reports the data source itself provides. As the information is collected for the matter, the algorithm steps through the identified sequence, changing the status as the stages in the mortgage proceed, and generating and issuing reports as required by user's interactively.

FIG. 12 illustrates the process flow of information within the system with respect to actions performed by various parties.

To initiate a mortgage report, a user may manually enter all or a portion of the pertinent information about the mortgage at the Manual Creation stage 1202, from within the web application. To initiate a mortgage report faster, and save on data entry tasks (and possibly associated errors), a user may import mortgage data directly from STEPS or other integrated services (as available) at the Import XML Data stage 1204. Stewart Title's STEPS provides an efficient import feature, allowing the system to import directly over a secured internet connection from partnering services, such as service.

With the primary data now collected, a Mortgage may be created at 1206 simply by populating the fields in the reports and storing it on the database 130. Once created, a mortgage record can follow a path of activities such as issuing reports and status checkpoints.

An Interim Report 1208, as shown in FIGS. 9a-9f, if required by the Lender, can be generated using mortgage data. The finished report can be sent via email, or published automatically as a PDF. If an issue arises, the mortgage record can be issued a hold status either by the user or by the Lender through the Lender dashboard.

A Funding Request 1210, as shown in FIGS. 10a-10f, can be generated using mortgage data to request an issuance of funding from the Lender. The request can be sent via email, or published automatically as a PDF. If an issue arises, the mortgage record can be issued a hold status either by the user or by the Lender through the Lender dashboard.

A notice that funding has been received can be issued through the segment “Funding Acknowledged” stage 1212 of the process.

A Final Report 1214, as shown in FIGS. 11a-11f, is generated using mortgage data. The finished report may then be sent via email, or published automatically as a PDF.

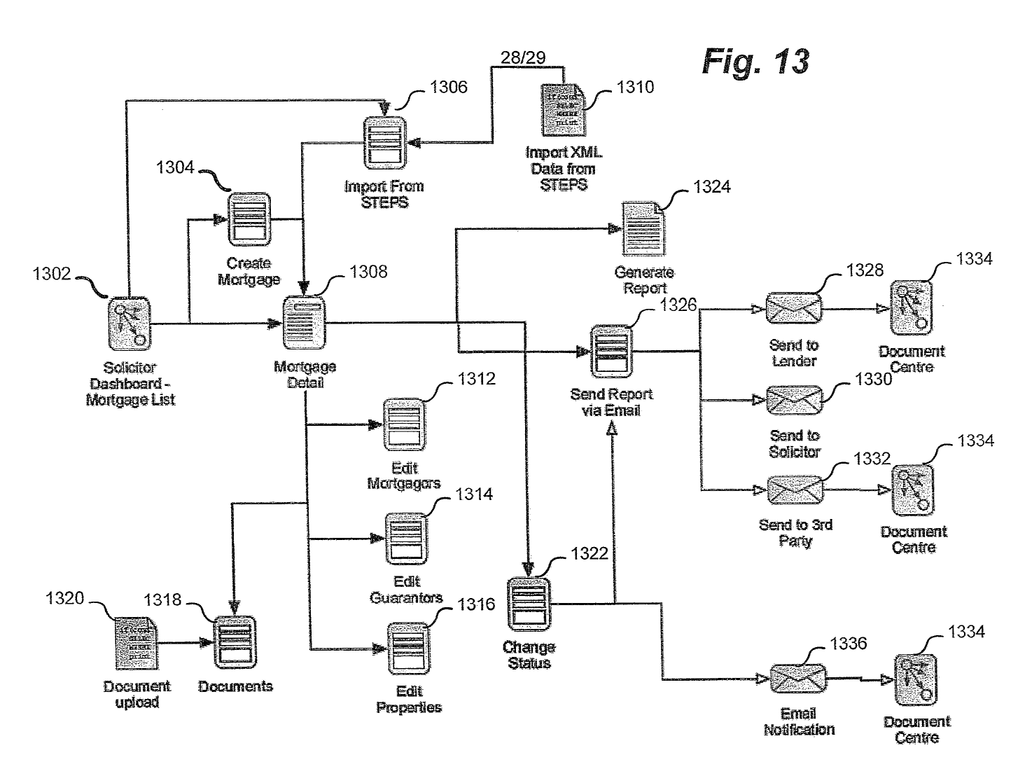

The Application Page flow diagram of FIG. 13 presents the process from the Solicitor's perspective. Again, from the GUI of FIG. 2, the Solicitor may generate new files, or access existing ones. The Solicitor may edit the fields of the data records using standard interface technology, issuing reports and updating file status. All additional electronic documents and articles associated with a Mortgage report are uploaded and stored in the document center, and the file status is updated when a report is issued.

The Solicitor Dashboard/Mortgage List 1302 (see FIG. 2) provides an overview of the working mortgage file to the user. It contains basic information regarding the mortgage, the completeness of the mortgage reporting process, and selectable actions for the user to initiate processes. From the Solicitor Dashboard/Mortgage List 1302 the user may have access to three primary processes:
The Create Mortgage form 1304—This form allows the creation of a mortgage file from scratch. It contains the basic fields required to initiate a basic set of Mortgage data;
The Import From Stewart Title Electronic Policy System (STEPS™) form 1306—This form allows the user to enter criteria to identify a mortgage file from the STEPS system, so that all existing pertinent XML data from STEPS may be imported into the system 1310; and
The Mortgage Detail tabs 1308 (see FIG. 3)—This set of tabs provides access to tables of all entered data within the Mortgage record, such as Mortgagors, Guarantors, Properties, Trust Account information, and Documents.

From the Mortgage Detail tabs 1308 the user has access to the following processes:
Edit Mortgagors 1312—This section allows data to be added/edited with regards to one or more mortgagors of the mortgage.
Edit Guarantors 1314—This section allows data to be added/edited with regards to one or more guarantors of the mortgage.
Edit Properties 1316—This section allows data to be added/edited with regards to one or more properties on the mortgage.
Documents 1318/Document Upload 1320 (see FIG. 4)—The documents section allows the user to upload electronic files such as PDFs, JPEG images or other filetypes to the web application from their desktop for inclusion in the Mortgage report package. Additionally, the user may download any specific document from this section.
Change Status 1322—The change status function allows the user to issue or address a change in status of the Mortgage. Comments may be added to supplement the change in status. As well, email notification of the changes may be issued 1336.
Generate Report 1324—The generate report function permits the user to create a snapshot of the current mortgage data. The snapshot is then converted into both an email report for delivery when requested by the user; and a PDF version of the Mortgage report. Because this is a snapshot, changes to the mortgage data do not affect the generated documents until the user chooses to Generate the documents again.
Email Notification/Send Report Via Email 1326—These functions allow a report or status change to be sent via email to a Lender 1328, Solicitor 1330 or third party 1332. If a report is sent, a server-generated, secured link is available to download the associated documents from the Document Centre 1334. The Document Centre 1334 (see FIGS. 5 and 6) is a secured distribution centre for documents associated to mortgages. To access a document a secure key, or passcode must be given to permit download.

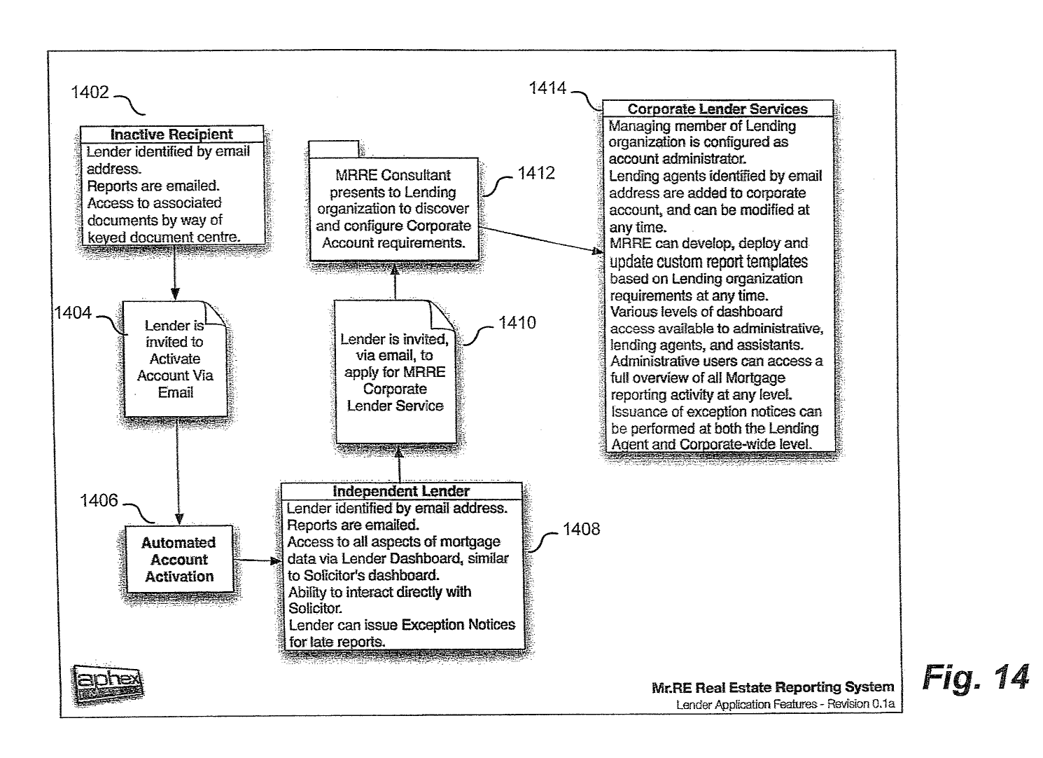

The Lender's Application Path of FIG. 14 presents the process from the perspective of the Banker or Mortgage Broker, showing varied levels of access and functionality based on the Lender's requirement for interaction. These parties have more limited access to the system in that they are not entitled to change certain data, but they still have access to view the data via a Lender's Dashboard similar to the Solicitor's Dashboard of FIG. 2. More specifically, three levels of access are shown in the exemplary Lender's Application Path of FIG. 14: an Inactive Recipient 1402, an Independent Lender 1408, and a Corporate Lender 1414.

At 1402 an “Inactive Recipient” Lender is identified by email address and is able to receive reports by email and have access to associated documents by way of the keyed document centre.

At 1404 the “Inactive Recipient” Lender is invited to activate his account via an email request. At 1406 the “Independent Lender” account is activated via an automated process, per the Lender's Document Centre access page of FIG. 5. At 1408 the “Independent Lender” is identified by email address, providing email delivery of reports to the Lender, and access to all aspects of the mortgage data via the Lender Dashboard is provided, similar to the Solicitors dashboard. This provides the ability to interact directly with the Solicitor. The Lender can then issue “Exception Notices” for late reports. The Lender may also download documents via the Lender's Document Download Centre of FIG. 6.

At 1410 the Lender is invited, via email, to apply for “Corporate Lender” services. At 1412 a Consultant contacts the Lending organization to discover and configure corporate account requirements. With “Corporate Lender” services 1414:
A Managing member of the Corporate Lender organization is configured as account administrator;
Lending agents identified by email address are added to the corporate account, and can be modified at any time;
The system can be used to develop, deploy and update custom report templates based on the Lending organization requirements at any time;
Various levels of dashboard access are available to administrative, lending agents, and assistants;
Administrative users can access a full overview of all Mortgage reporting activity at any level; and

Issuance of exception notices can be performed at both the Lending Agent and Corporate-wide level.

### Underlieing Technology

The system uses technology such as the Apache Web Server which is a free software/open source HTTP web server for Unix-like systems (BSD, Linux, and UNIX systems), Microsoft™ Windows™, Novell™ NetWare™ and other platforms. Apache is notable for playing a key role in the initial growth of the World Wide Web, and continues to be the most popular web server in use, serving as the reference platform against which other web servers are designed and judged. Apache features highly configurable error messages, DBMS-based authentication databases, and content negotiation. It is also supported by several graphical user interfaces (GUIs) which permit easier, more intuitive configuration of the server.

The Apache HTTP Server is developed and maintained by an open community of developers under the auspices of the Apache Software Foundation. Apache is primarily used to serve static and dynamic content on the World Wide Web. Many web applications are designed expecting the environment and features that Apache provides. Apache is the web server component of the popular web server application stack called LAMP (Linux, Apache, MySQL, PHP/Perl/Python). Apache is redistributed as part of various proprietary packages, for example: the Oracle database or the IBM™ WebSphere™ application server. Mac™ OS X integrates Apache as its built-in web server.

PHP Application Server—(http://www.php.net) is an open-source, reflective programming language. Originally designed as a high-level tool for producing dynamic web content, PHP is used mainly in server-side applications. When running server-side, the PHP model can be seen as an alternative to Microsoft's ASP.NET/C#IVB.NET system, Macromedia™'s ColdFusion™, Sun Microsystems™ JSP™, Zope, mod_perl and the Ruby on Rails framework. The LAMP architecture has become popular in the Web industry as a way of deploying inexpensive, reliable, scalable, secure web applications. PHP is commonly used as the P in this bundle alongside Linux, Apache and MySQL. PHP can be used with a large number of relational database management systems, runs on all of the most popular web servers and is available for many different operating systems. This flexibility means that PHP has a wide installation base across the Internet.

MySQL Database Server—(http://www.mysql.com) MySQL is a multithreaded, multi-user, SQL Database Management System (DBMS) with more than six million installations. MySQL AB makes MySQL available as free software under the GNU General Public License (GPL), but they also dual-license it under traditional proprietary licensing arrangements for cases where the intended use is incompatible with the GPL. Its popularity as a web application is closely tied to the popularity of PHP, which is often combined with MySQL and nicknamed the Dynamic Duo. It is easy to find many references that combine the two in websites and books.

Nitrogen™ Application Framework—Developed by Aphex Imaging Inc. (http://www.apheximaging.com), Nitrogen is an object-oriented web application framework devised of a collection of integrated PHP code organized into structured classes. This framework is developed to be universal in nature, to provide a basis for developing specialization applications in numerous, diverse business areas.

JavaScript™ is the name of Netscape Communications Corporation™'s implementation of ECMAScript, a scripting programming language based on the concept of prototypes. The language is best known for its use in websites, but is also used to enable scripting access to objects embedded in other applications. Despite the name, JavaScript is only distantly related to the Java programming language, the main similarity being their common debt to the C programming language. JavaScript has far more in common with the Self programming language.

AJAX is an acronym for Asynchronous Javascript And XML, which is a method for enhancing web application interactivity and visualization. It is commonly known as the primary underlying technology behind the Web 2.0 movement.

The Extensible HyperText Markup Language, or XHTML, is a markup language that has the same expressive possibilities as HTML, but a stricter syntax. Whereas HTML is an application of SGML, a very flexible markup language, XHTML is an application of XML, a more restrictive subset of SGML. Because they need to be well-formed (syntactically correct), XHTML documents allow for automated processing to be performed using a standard XML library—unlike HTML, which requires a relatively complex, lenient, and generally custom parser (though an SGML parser library could possibly be used). XHTML can be thought of as the intersection of HTML and XML in many respects, since it is a reformulation of HTML in XML.

Cascading Style Sheets (CSS) is a stylesheet language used to describe the presentation of a document written in a markup language. Its most common application is to style web pages written in HTML and XHTML, but the language can be applied to any kind of XML document, including SVG and XUL. The CSS specifications are maintained by the World Wide Web Consortium (W3C). In order to maintain standards compliance, it is recommended that CSS code be validated before release.

The Extensible Markup Language (XML) is a W3C-recommended general-purpose markup language for creating special-purpose markup languages, capable of describing many different kinds of data. In other words: XML is a way of describing data and an XML file can contain the data too, as in a database. It is a simplified subset of Standard Generalized Markup Language (SGML). Its primary purpose is to facilitate the sharing of data across different systems, particularly systems connected via the Internet. Languages based on XML (for example, Geography Markup Language (GML), RDF/XML, RSS, Atom, MathML, XHTML, SVG, and MusicXML) are defined in a formal way, allowing programs to modify and validate documents in these languages without prior knowledge of their form.

SOAP is a protocol for exchanging XML-based messages over a computer network, normally using HTTP. SOAP forms the foundation layer of the Web services stack, providing a basic messaging framework that more abstract layers can build on. SOAP can be used to facilitate a Service-Oriented architectural pattern. There are several different types of messaging patterns in SOAP, but by far the most common is the Remote Procedure Call (RPC) pattern, in which one network node (the client) sends a request message to another node (the server), and the server immediately sends a response message to the client. Indeed, SOAP is the successor of XML RPC.

Secure Sockets Layer (SSL) and Transport Layer Security (TLS), its successor, are cryptographic protocols which provide secure communications on the Internet. There are slight differences between SSL 3.0 and TLS 1.0, but the protocol remains substantially the same. The term “SSL” as used here applies to both protocols unless clarified by context.

SSL provides endpoint authentication and communications privacy over the Internet using cryptography. In typical use, only the server is authenticated (i.e. its identity is ensured) while the client remains unauthenticated; mutual authentication requires public key infrastructure (PKI) deployment to clients. The protocols allow client/server applications to communicate in a way designed to prevent eavesdropping, tampering, and message forgery.

Model-view-controller (MVC) is a software architecture that separates an application's data model, user interface, and control logic into three distinct components so that modifications to one component can be made with minimal impact to the others. MVC is often thought of as a software design pattern. However, MVC encompasses more of the architecture of an application than is typical for a design pattern. Hence the term architectural pattern may be useful or perhaps an aggregate design pattern.

### Options and Alternatives

The invention has been described with respect to various examples and embodiments. It is very clear however, that many modifications and variations may be effected without departing from the true scope and spirit of the invention. For example:
1. Client Reporting—This feature enables a template-based report to be sent to the Mortgagor (client) of a Mortgage record. This report adds value to the Solicitor's service to the client. The method in which this service is enabled adds functionality to define the Mortgagor's email address and the ability to submit the report electronically on completion of the Final Report. Optionally, a downloadable PDF document version may be generated for offline packaging (CDROM, etc.), or printing and delivery to the client.
2. elnstructions (electronic mortgage instruction), provides the ability to issue mortgage instructions from the existing Lender Dashboard to the Solicitor. This allows the Lender to pre-define an arbitrary portion of Mortgage information, effectively increasing the efficiency in which a Solicitor can accurately report on the completion of a Mortgage transaction; and
3. SOAP-based mortgage reporting pipeline is an application of the SOAP-protocol which allows partnered companies to interact with Mortgage records through a number of pre-defined actions available through a secured Internet tunnel as system-to-system processes. This permits the transfer of data, documents, mortgage status and associated information from one organizations database application to and from the web application either through user-controlled means, or via automated server-level actions. The SOAP facility, web application-API (MRRE Application Programming Interface), may be made available as a subscription- or partner-based solution.

Other options and alternatives would be understood to those skilled in the art from the description of the invention as provided herein.

### CONCLUSION

The method as provided in the present disclosure may be presented in executable machine code stored in a variety of formats such as object code or source code. Clearly, the executable machine code may be integrated with the code of other programs, implemented as subroutines, by external program calls, in firmware or by other techniques as known in the art.

The system may be executed by a computer processor or similar device programmed in the manner of method, or may be executed by an electronic system which is provided with means for executing these steps. Similarly, an electronic memory medium such computer diskettes, CDs, DVDs, Random Access Memory (RAM), Read Only Memory (ROM) or similar computer software storage media known in the art, may be programmed to execute such method steps. As well, electronic signals representing these method steps may also be transmitted via a communication network.

All citations are hereby incorporated by reference. The embodiments described above are intended to be illustrative only. The scope of the invention is therefore intended to be limited solely by the scope of the appended claims.

1. A method of providing web-based mortgage reporting and management, the method comprising the steps of:
creating a mortgage;
generating a mortgage report;
generating a funding request;
receiving a funding acknowledgement; and
generating a final report.

2. The method of claim 1 wherein said step of generating a final report comprises the step of generating a seller's report.

3. The method of claim 1 wherein said step of generating a final report comprises the step of generating a partner's report.

4. The method of claim 1 wherein the mortgage is created by manual entry.

5. The method of claim 1 wherein the mortgage is created by importing XML data.

6. The method of claim 1 further comprising the step of creating email notification and each step, the email notification is directed to a pre-defined recipient.

7. The method of claim 1 wherein the step of generating the mortgage report further comprises sending the report to a Lender and Solicitor.

8. A system for web-based mortgage reporting and management comprising:
a memory;
a processor for executing the steps of:
creating a mortgage;
generating a mortgage report;
generating a funding request;
receiving a funding acknowledgement; and
generating a final report.

9. The system of claim 8 wherein said final report is a mortgagee's report.

10. The system of claim 8 wherein said final report is a seller's report.

11. The system of claim 8 wherein said final report is a partner's report.

12. The system of claim 8 wherein the mortgage is created by manual entry.

13. The system of claim 8 wherein the mortgage is created by importing XML data.

14. The system of claim 8 further comprising the step of creating email notification and each step, the email notification is directed to a pre-defined recipient.

15. The system of claim 8 wherein the step of generating the mortgage report further comprises sending the report to a Lender and Solicitor.
